(19) United States
(12) Patent Application Publication
(10) Pub. No.: US 2017/0134159 A1
(43) Pub. Date: May 11, 2017

(54) Systems and methods for aggregating encrypted data

(71) Applicant: Sze Yuen Wong, Herndon, VA (US)

(72) Inventor: Sze Yuen Wong, Herndon, VA (US)

(21) Appl. No.: 14/933,512

(22) Filed: Nov. 5, 2015

(51) Int. Cl. H04L 9/06; H04L 9/14; G06F 17/30

(52) U.S. Cl. CPC H04L 9/0618; G06F 17/30312; H04L 9/14; H04L 2209/24; H04L 2209/34

(57) ABSTRACT

The present invention is directed to methods and systems in which TNO ciphertexts are grouped into targeted selections for distributed aggregation. A user selects certain initial data records for Stage-1 processing, which performs mapping operations and partitioning with the data records. An owner key is obtained from the data owner for encrypting and decrypting of the TNO ciphertexts. Consents are obtained from the data subjects for encrypting and decrypting of partition keys and indexes. Stage-2 processing are distributed among multiple processing units based on the indexes, where associated TNO ciphertexts are decrypted and processed to obtain aggregate data.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

This invention is generally related to distributed processing of encrypted data. Specifically, this invention relates to targeted selection of data secured in a Trust-No-One approach.

### BACKGROUND OF THE INVENTION

Trust no one or TNO, is an approach towards securing data in which an owner is given sole access control to the data, in such a way that it will not be possible for even a system operator to access the data without the owner's trust or consent. A data record that is secured in the TNO approach is called a TNO ciphertext, where security is usually baked into the TNO ciphertext itself by applying some sort of encryption in such a way that an owner's key is the only way to reveal the data. A system that provides storage to TNO ciphertexts is called a TNO server, which typically provides some sort of access control in addition to the CRUD (create, retrieve, update, delete) database functions. While encapsulating a data record together with its protection in one unit of TNO ciphertext achieves most fundamental protection that is independent of its storage and processing locations, a TNO server can provide enhancements such as integration of key-based access control and owner-keys.

A TNO processing unit is a computer execution unit that is capable of processing data in a TNO compatible approach. A TNO processing unit can be a single chip, a computer system, or multiple computer systems networked together. While a TNO processing unit provides certain advantages to data processing, the advantages also come at a cost where large amount of encryption and decryption activities can incur a high performance overhead. In the particular case of aggregating over a large dataset, the cost of decrypting large amount of TNO ciphertexts can quickly become a performance bottleneck, as the performing of aggregation typically involves grouping activities that require frequent access to an entire dataset in order to determine group membership for each individual data records. Distributed processing techniques such as MapReduce is commonly used to enhance the performance of aggregation over a large dataset. A MapReduce process typically comprises of two stages. In stage 1, mapping of a number of initial data records is performed to obtain the same number of Stage-1 data records. In stage 2, the Stage-1 data records are further reduced to one or more groups containing exactly one aggregate data in each of the groups. Additional techniques also include codifying group memberships into partitions to facilitate sharing and distributed processing.

Expressing in Big-O notation, the efficiency of a Stage-1 mapping operations and a Stage-2 reduction operations are both measured to be O(n), where n is the number of Stage-1 data records. Typically, performance optimization can be achieved by distributing Stage-2 reduction operations to multiple computing processing units for processing. In the case of processing reduction of TNO ciphertexts, however, the need for decrypting an entire dataset in order to determine group membership for each individual data records becomes a real performance issue, as the resulting performance will easily degrade to O(n\hat{2}) or worse.

Some attempted solutions have tried to perform grouping in stage 1 by including a data record with its group membership together in the same TNO ciphertext, but this has not addressed the needs of the distributed processing of reduction operations as the group membership are encrypted and concealed within the TNO ciphertexts. As a result, when there are multiple Stage-2 processing units, it becomes necessary for each one of the processing units to decrypt the same entire set of TNO ciphertexts in order to discover the data records and their group memberships.

In yet some other attempted solutions, groupings are performed in stage 2 instead, but this once again has not addressed the needs of distributed processing of reduction operations, as when there are multiple Stage-2 processing units available for processing, each one of the processing unit still needs to decrypt the entire dataset in order to perform grouping and to select group members for processing.

Privacy is also an issue with distributed aggregation that involves sensitive identifying data. Applicable law and regulations typically prohibit use and disclosure without strictly enforced access control and data subject's consent. Sanitization is needed prior to distribution so that both aggregate data and their group information are de-identified. Re-identification should be subjected to privacy control and become available only in the presence of explicit consent given by data subjects.

In this application, the inventor has improved upon previous techniques by developing a data refining system for performing distributed aggregation more securely and efficiently. Firstly, by means of partitioning, targeted selection of TNO ciphertexts that are strategically grouped together by partition keys can be distributed for processing across multiple of machines, resulting in more efficient memory utilization individually on each machine, as well as overall system performance improvement by processing distributed partitions concurrently on multiple connected machines.

Secondly, security enhancement is a result of employing a genuine TNO approach of processing in the absence of any system keys. While TNO data storage provide excellent protection of data-at-rest, the inventor is able to leverage TNO techniques in processing targeted selections to provide enhanced safeguards for the protection of data-in-use when being processed in memory, whereas only records of targeted partitions are loaded in memory at any single point of time. As a result, in the event of a breach, only a limited number of partitions that are in memory at that time is exposed.

Last but not the least, privacy control is enhanced via capabilities to de-identify and re-identify based on owner-keys and consents from data subjects.

### SUMMARY OF THE INVENTION

The present invention is directed to methods and systems in which TNO ciphertexts are grouped into targeted selections for distributed aggregation. Trust no one or TNO, is an approach towards securing data in which an owner is given sole access control to the data, in such a way that it will not be possible for even a system operator to access the data without the owner's trust or consent. Partitioning TNO ciphertexts into targeted selections allows more efficient memory utilization individually on each machine, as well as overall system performance improvement by processing distributed partitions concurrently on multiple connected machines. While TNO data storage provide excellent protection of data-at-rest, processing with targeted partitions limits number of data records in memory at any single point of time, thereby limiting risk of exposure in the event of a breach. Privacy control is enhanced via capabilities to de-identify and re-identify based on owner-keys and consents from data subjects.

### BRIEF DESCRIPTION OF THE DRAWINGS

FIG. 1 is a simplified block diagram of one embodiment of the present invention implemented on a single processing unit, equipped with a job controller, an internal Index Cache, a Mapping Core, and a Reduction Core.

FIG. 2 is a simplified block diagram of one embodiment of the present invention implemented on a single processing unit, equipped with a job controller, a Mapping Core, and a Reduction Core, where an external Index Cache is connected to both the Mapping Core and the Reduction Core.

FIG. 3 is a simplified block diagram of one embodiment of the present invention in which a preprocessing unit is equipped with a job controller and a Mapping Core for performing data filtering and transformation.

FIG. 4 is a simplified block diagram of one embodiment of the present invention in which a Stage-1 processing unit and a Stage-2 processing unit are combined to work with a TNO server to perform aggregation.

FIG. 5 is a simplified block diagram of one embodiment of the present invention in which a complete data refining system comprises a preprocessing unit, a Stage-1 processing unit, and a Stage-2 processing unit.

FIG. 6 is a flow diagram of a method according to an embodiment of the Stage-1 processing unit performing a first stage of data refining.

FIG. 7 is a trust model diagram of dissemination of the Stage-1 data records and the partitions shown in FIG. 6 across trust boundaries.

FIG. 8 is a flow diagram of a method according to an embodiment of the Stage-2 processing unit performing a second stage of data refining.

FIG. 9 is a simplified block diagram of an embodiment in which multiple Stage-2 processing units are deployed to perform distributed reduction operations.

FIG. 10 is a flow diagram of a method according to an embodiment of the present invention in which user-supplied settings are provided to configure a Stage-1 processing unit.

FIG. 11 is a flow diagram of a method according to an embodiment of the present invention in which user-supplied settings are provided to configure a Stage-2 processing unit.

FIG. 12 is a flow diagram of a method according to an embodiment of the present invention in which user-supplied settings are provided to configure a preprocessing unit.

FIG. 13 is a flow diagram of a method according to a preferred embodiment of the Stage-1 processing unit performing de-identification based on the Stage-1 process shown in FIG. 6.

FIG. 14 is a flow diagram of a method according to a preferred embodiment of the Stage-2 processing unit performing re-identification based on the Stage-2 process shown in FIG. 8.

FIG. 15 is a sample of a data transformation flow in which TNO records are grouped into partitions in a Stage-1 processing.

FIG. 16 is a sample of a data transformation flow in which partitions are reduced into aggregate values in a Stage-2 processing.

FIG. 17 is a sample of a data transformation flow in which a multilevel data structure is flattened into a one-level structure.

### DETAILED DESCRIPTION OF THE INVENTION

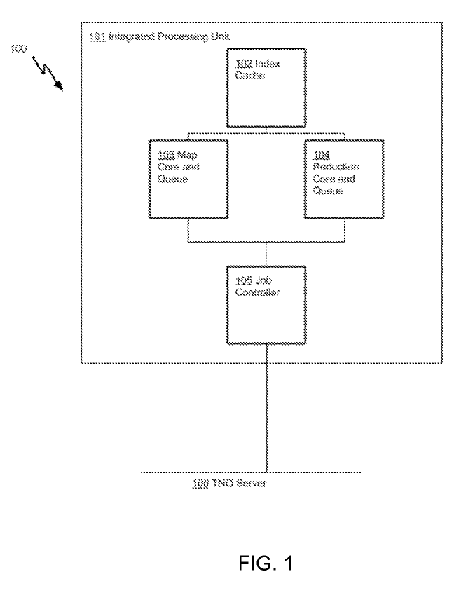

FIG. 1 is a simplified block diagram 100 of an embodiment of implementing a two-stage TNO aggregation processing model using an integrated processing unit 101, comprising of a Mapping Core 103 and a Reduction Core 104. The Mapping Core 103 is responsible for performing mapping operations in the aggregation process, while the Reduction Core 104 is responsible for reduction operations in the aggregation process. There is also a job controller 105 and an Index Cache 102 integrated on the same processing unit 101. The job controller 105 is responsible for transferring data among the two cores and a TNO server 106, while the Index Cache 102 supports sharing of partitions between the Mapping Core 103 and the Reduction Core 104.

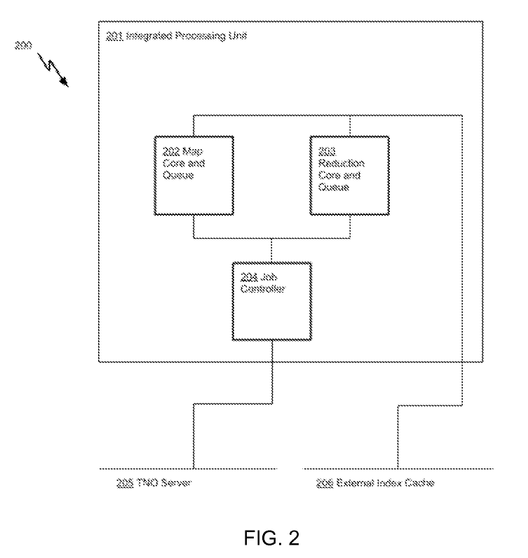

FIG. 2 is a simplified block diagram 200 of an alternate embodiment of the present invention in which the Mapping Core 202 and the Reduction Core 203 are connected to an Index Cache 206 external to the processing unit 201.

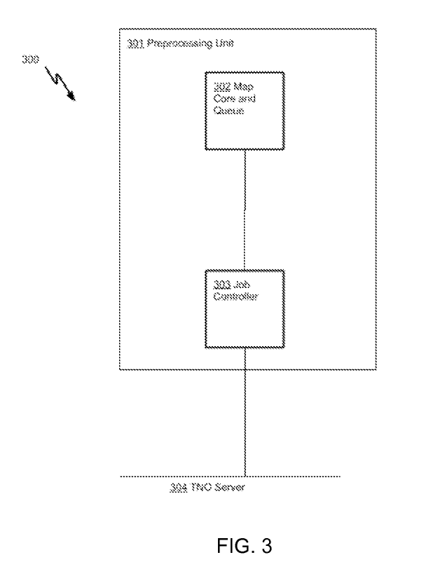

FIG. 3 is a simplified block diagram 300 of an alternate embodiment of implementing a preprocessing unit 301 by using a Mapping Core 302 alone without any Reduction Core. The preprocessing unit 301 is capable for using the Mapping Core 302 to perform the usual filtering and transformation operations. The job controller 303 installed on the preprocessing unit 301 is responsible for data transfer between the TNO server 304 and the preprocessing unit 301 by means of encryption and decryption, so that initial data records required for filtering and transformation would be available to the Mapping Core 302. In one embodiment, the Mapping Core 302 is used in a data refining system to transform initial data records having a nested structure into a flattened structure.

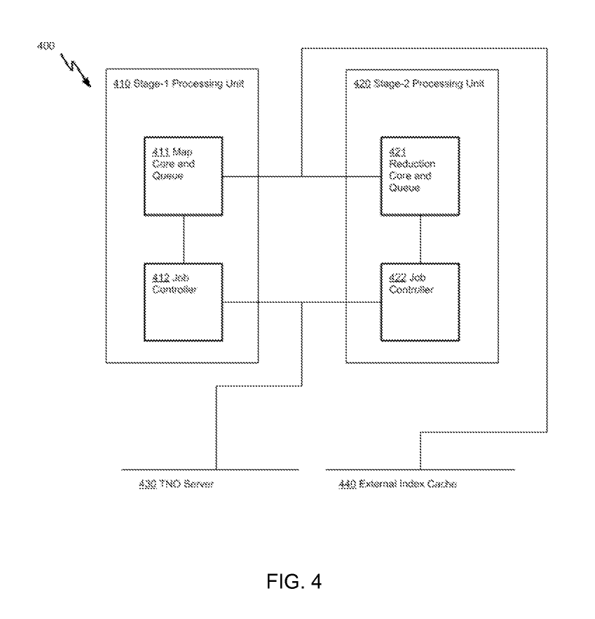

FIG. 4 is a simplified block diagram 400 of an alternate embodiment of the present invention in which mapping operations and reduction operations are separated to perform on a Stage-1 processing unit 410 and a Stage-2 processing unit 420 respectively. The Stage-1 processing unit 410 comprises of a Mapping Core 411 and a job controller 412, where the job controller 412 is responsible for making initial data records available to the mapping operations, and at the same time taking output of Stage-1 data records from the Mapping Core 411 to save in the TNO server 430. The Mapping Core 411 is also responsible for transferring containing partitions of the Stage-1 data records to the external Index Cache 440. Likewise, the Reduction Core 421 also comprises of a second job controller 422 and a Reduction Core 421, where the second job controller 422 is responsible for retrieving and decrypting the TNO ciphertexts to obtain the Stage-1 data records for the Reduction Core 421 to perform reduction operations. In some alternate embodiments, the job controller 422 is also responsible for encrypting the output from the Reduction Core 421 to save in the TNO server 430. Further, the Reduction Core 421 also obtains partitions from the Index Cache 440.

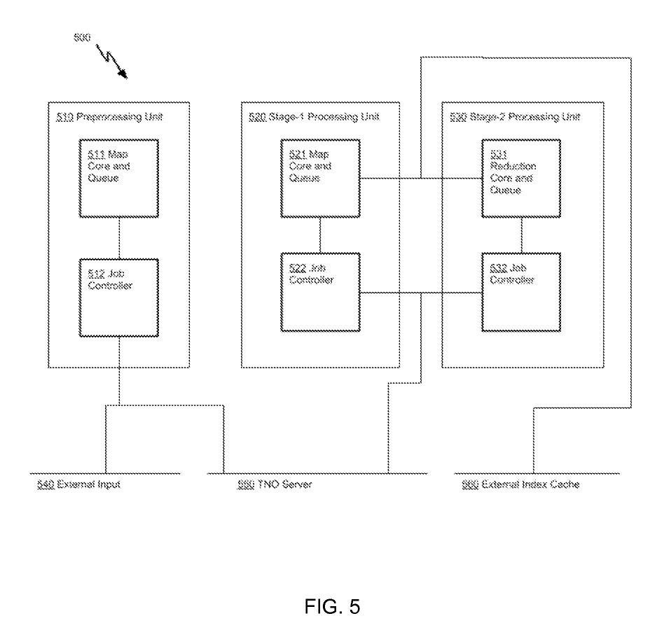

FIG. 5 is a block diagram 500 of a preferred embodiment of the present invention comprising a preprocessing unit 510, a Stage-1 processing unit 520, and a Stage-2 processing unit 530. The preprocessing unit 510 is responsible for accepting initial data records from external input sources 540, the Stage-1 processing unit 520 is responsible for mapping operations, and the Stage-2 processing unit 530 is responsible for reduction operations. The Stage-1 processing unit 520 and the Stage-2 processing unit 530 share partitions via a connected external Index Cache 560. The Stage-1 processing unit 520 comprises of a first job processor 522 as shown in FIG. 4, while the Stage-2 processing unit 530 comprises of a second job processor 532 also as shown in FIG. 4.

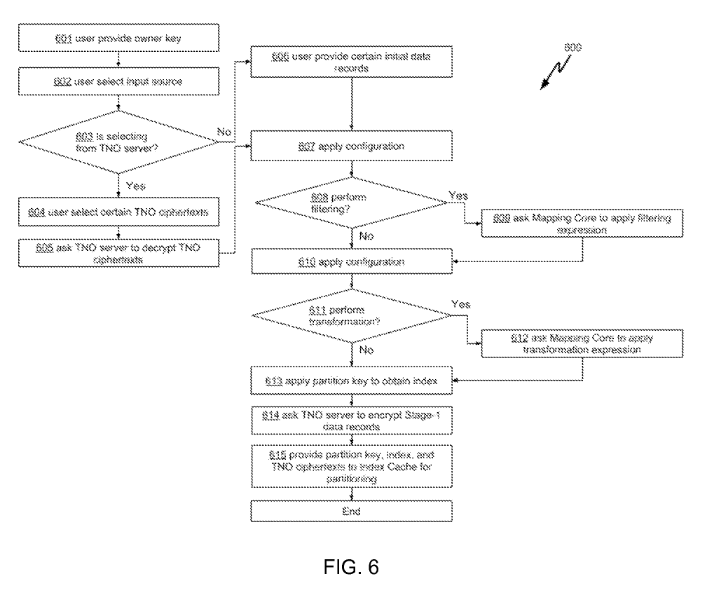

FIG. 6 is a flow diagram 600 of an embodiment of a process for transforming initial data records into Stage-1 TNO ciphertexts by using the Stage-1 processing unit shown in FIGS. 4 and 5. The job controller checks for user selection 602, which can either be initial data records 606 coming from external input sources, or the user selection can be TNO ciphertexts already encrypted in a TNO server 603, in which case an owner key 601 will be applied to the TNO ciphertexts 604 to obtain the data records 605. Further, based on user selection and settings 607, the job controller provides to the Mapping Core a partition key, a filtering expression, and a transformation expression for performing mapping operations. The Mapping Core in turn applies the filtering expression 609 followed by the transformation expression 612 to transform the initial data records into Stage-1 data records. Still further, the job controller de-identifies the Stage-1 data records by removing all sensitive identifying data, encrypts to them become Stage-1 TNO ciphertexts 614, and sends to the TNO server for storage. Still further, the Mapping Core groups the same initial data records by the partition key 613 to obtain one or more partitions, associates the de-identified Stage-1 TNO ciphertexts with the partitions, and transfers the partitions to the Index Cache for storage 615. The Index Caches would encrypt the partitions by using an explicit consent from the data subject as a key to the encryption, resulting in a key-based access control model where access can only be granted at the presence of the explicit consent. By combining the key-based access control model and the employed TNO security model where access is only possible at the presence of an owner key from the data owner, the result is a powerful two-factor data privacy safeguard.

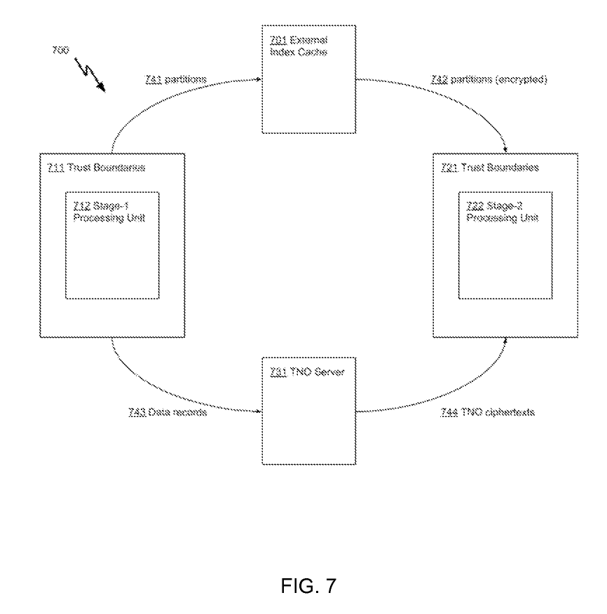

FIG. 7 is a trust model 700 of processing of Stage-1 TNO ciphertexts 744 and partitions 742 by a third party Stage-2 processing unit 722. The Stage-1 data records 743 and the partitions 7041 are both encrypted by the Stage-1 processing unit 712 to put in the TNO server 731 and the Index Cache 701 respectively as shown in FIG. 6. Both the Stage-1 TNO ciphertexts 744 and the encrypted partitions 742 are protected when being disseminated to the third party 7022, and because the ciphertext essentially encapsulates data with their safeguards together as one physical unit in transit, it becomes possible to enforce safety and integrity when disseminating the protected data across trust boundaries 711, 712 in a distributed processing network.

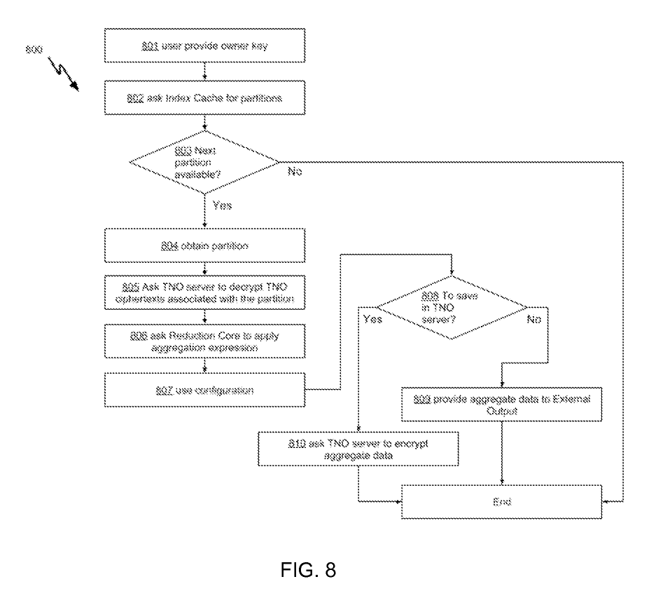

FIG. 8 is a flow diagram 800 of an embodiment of a process for reducing Stage-1 TNO ciphertexts and partitions into aggregate data by using the Stage-2 processing unit shown in FIGS. 4 and 5. The job controller asks the Reduction Core to perform reduction operations if partitions are available in the Index Caches 802. If partitions are found 803 in the Index Caches, the Reduction Core asks the job controller for the associated Stage-1 TNO ciphertexts 805, which the job controller in turn selects from the TNO server to provide for the Reduction Core. Further, the Reduction Core performs reduction operations 806 to transform the Stage-1 data records into aggregate data, which can be re-identified at the presence of an explicit consent from the data subject. Still further, the job controller checks for user settings 807 to optionally encrypt the Stage-2 aggregate data 810 with an owner key 801 for saving in the TNO server.

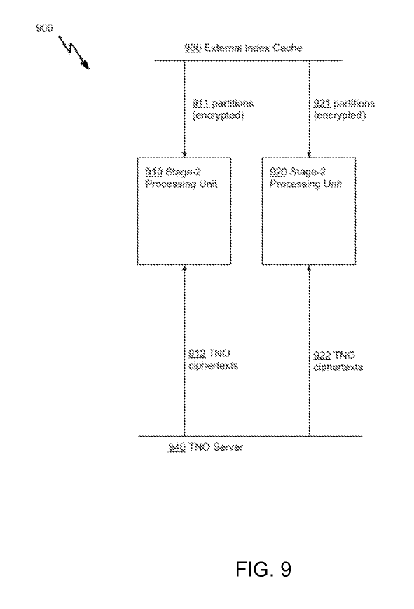

FIG. 9 is a block diagram 900 of a preferred embodiment in which multiple Stage-2 processing units 910, 920 are deployed to distribute reduction operations. Partitions 911, 921 are distributed from an Index Cache 930 across the processing units 910, 920. Loading of TNO ciphertexts 912, 922 into processing units 910, 920 are controlled based on the targeted selections and partitions 911, 921 that they belong to, thereby avoiding any needs to decrypt an entire dataset residing in a TNO server 940, thus making it possible to enhance performance via efficient memory usage for each of the processing units 910, 920.

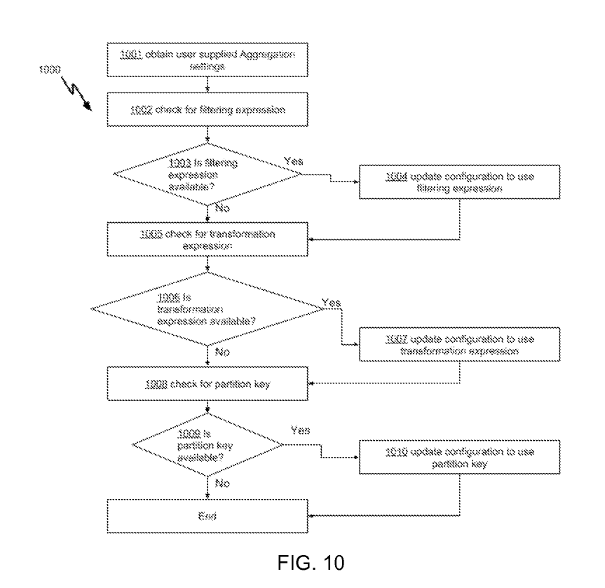

FIG. 10 is a flow diagram 1000 of an embodiment of a process for configuring a Stage-1 processing unit based on user-supplied settings 1001, which include but not limited to a partition key 1008, a filtering expression 1002, and a transformation expression 1005. If any of these settings are available, the job controller would provide them to the Mapping Core for configuration 1004, 1007, 1010.

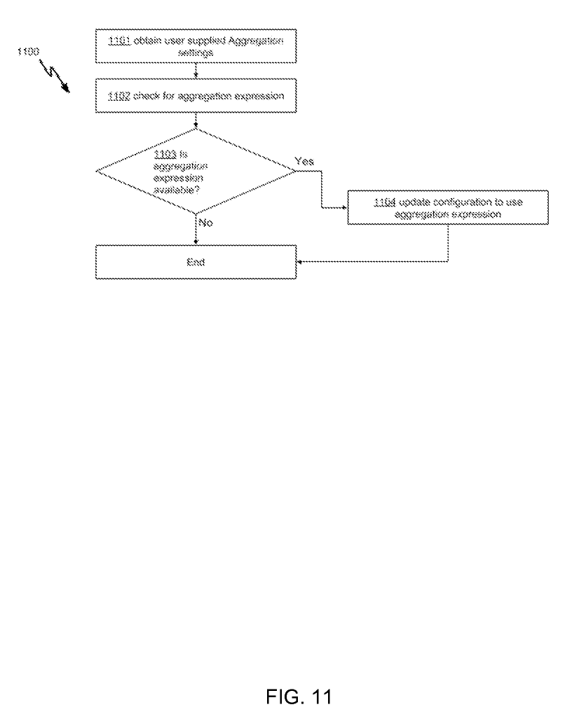

FIG. 11 is a flow diagram 1100 of an embodiment of a process for configuring 1104 a Stage-2 processing unit by using an aggregation expression 1102 based on user-supplied settings 1101.

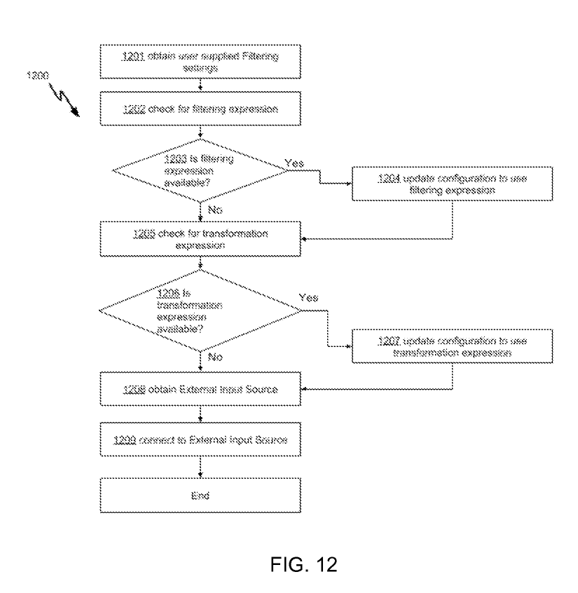

FIG. 12 is a flow diagram 1200 of a preferred embodiment of a process for configuring a preprocessing unit. User-supplied settings 1201 can optionally provide a filtering expression 1203, a transformation expression 1206, and properties for establishing connections to external input sources 1208.

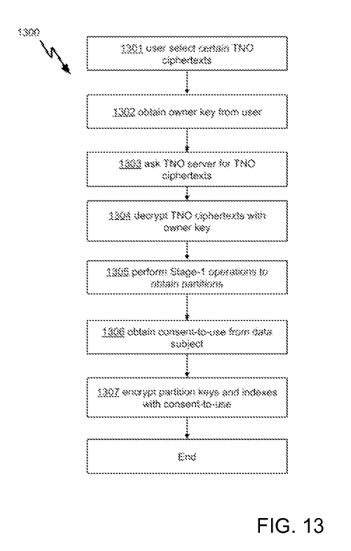

FIG. 13 is a flow diagram 1300 of a preferred embodiment of a process for performing Stage-1 mapping operations with the use of an owner key obtained from an owner of data 1302, as well as a consent-to-use from a data subject of the data 1306. The owner key is used for decrypting 1304 selected TNO ciphertexts 1301 for performing of the mapping operations, which results in partition keys and indexes 1305. The consent-to-use is used to encrypt the partition keys and indexes for privacy control 1307.

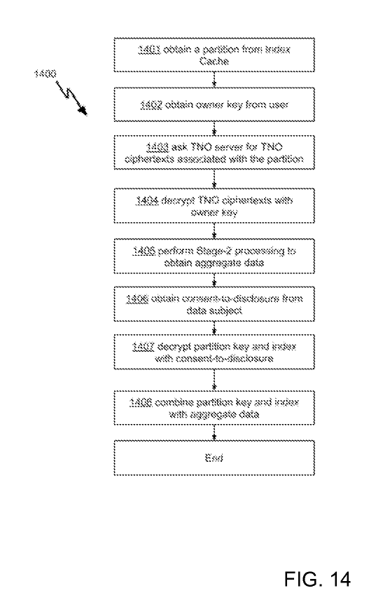

FIG. 14 is a flow diagram 1400 of a preferred embodiment of a process for performing reduction operations by utilizing both an explicit consent 1406 and an owner key 1402 in a Stage-2 processing unit. A job controller of the processing unit obtains a partition 1401 containing members of Stage-1 TNO ciphertexts 1403. Targeted selection of TNO ciphertexts is made possible by using a partition, because without the partition It is otherwise very difficult to discover group membership directly from a TNO server because the entire dataset would have been encrypted and any group membership information would have been concealed. Instead, being able to perform targeted selection of TNO ciphertexts allows the processing unit a better control of memory usage and enhanced system performance. Further, the processing unit performs reduction operations to transform the decrypted Stage-1 data records into aggregate data for the partition 1405. Privacy protection is inherent in the processing that begins with partitions and Stage-1 data records that are both de-identified. Further, at the presence of an explicit consent from a data subject, the job controller uses the explicit consent as a key to decrypt both of the partition key and the index from the partition 1407, and to combine both of them with the aggregate data for re-identification 1408.

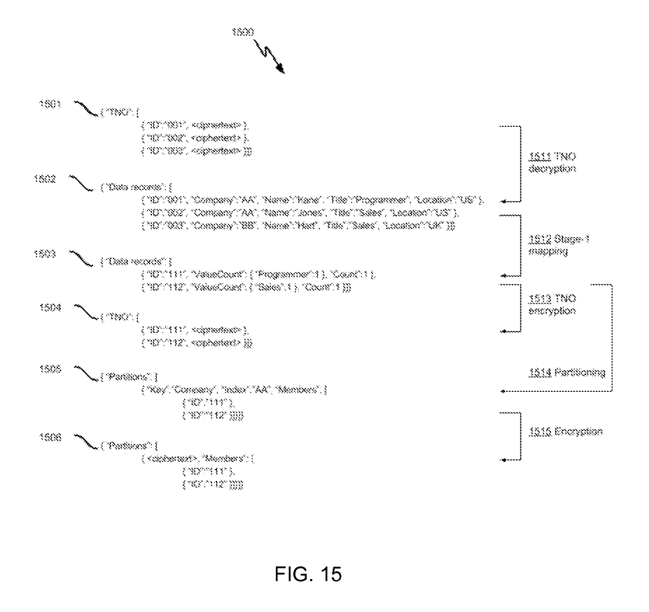

FIG. 15 is a sample of transformation diagram 1500 in which initial data records 1502 are transformed into Stage-1 TNO ciphertexts 1504 as a result of the first stage of the data refining process. The Stage-1 mapping operations begin by decrypting 1511 a set of three TNO ciphertexts 1501 to obtain corresponding initial data records 1502. Filtering and transformation are then applied 1512 to the initial data records 1502 to obtain a corresponding Stage-1 data records 1503, which is then encrypted 1513 to become TNO ciphertexts 1504. Further, the Stage-1 data records 1503 are grouped by a partition key 1514 to obtain the partitions 1505, which is then further encrypted 1515.

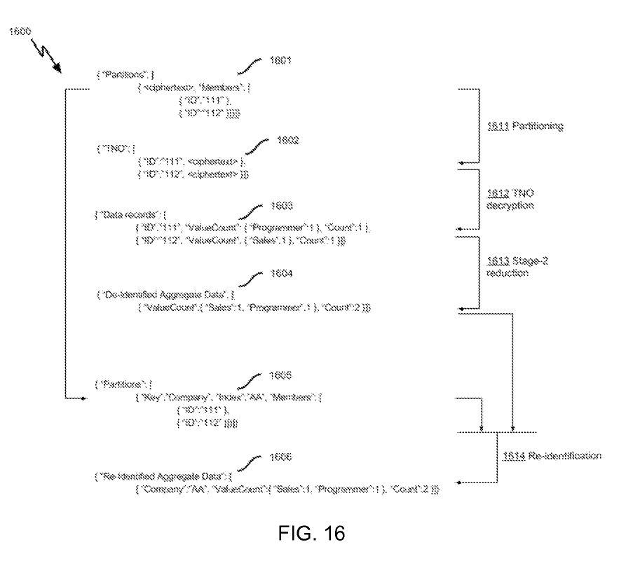

FIG. 16 is a sample of transformation diagram 1600 in which the output of the Stage-1 TNO ciphertexts in FIG. 15 is further processed in a Stage-2 processing unit for reduction operations. The process begins by decrypting the partitions 1601, retrieving 1611 and decrypting 1612 the corresponding TNO ciphertexts 1602, and follows by performing reduction 1613 to obtain de-identified aggregate data 1604. Further, the process decrypts the partitions to obtain the partition key and the index 1605, which are combined with the aggregate data 1606 to achieve re-identification 1614.

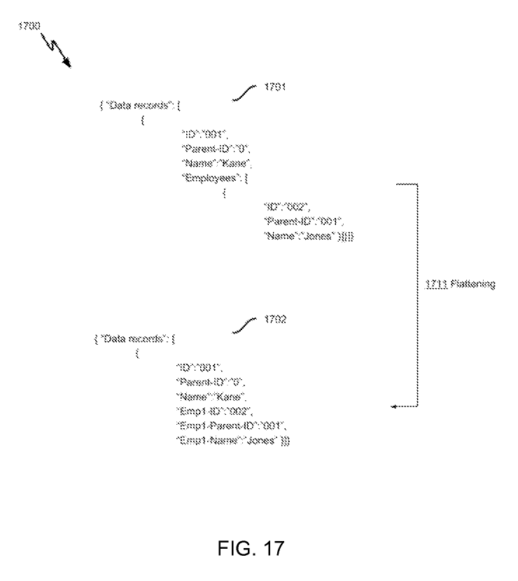

FIG. 17 is a sample of transformation diagram 1700 depicting a data record 1701 of a nested structure and the corresponding resulting structure 1702 after being flattened by using a preprocessing unit. The preprocessing unit makes use of a Map Core's capabilities to transform 1711 a nested structure into a flat structure. Any individual key-value pairs originally at a deeper level are moved to the top level by giving each pair a new key that is unique across all pairs in the same data record. In one embodiment, a unique key is created by combining a key in a pair to the name of the containing data record.

What is claimed is:

1. A computer implemented method of aggregating encrypted TNO ciphertexts grouped into targeted selections, wherein loading of TNO ciphertexts into memory is limited to the targeted selections that are being aggregated, the method comprising:
a. mapping over a targeted selection associated with a partition, wherein the mapping comprises:
i. obtaining an initial data record;
ii. performing mapping operations to transform the initial data record into a Stage-1 data record;
iii. generating an index that identifies the partition based on the Stage-1 data record in accordance with a partition key;
iv. encrypting the Stage-1 data record with an owner key from an owner of the initial data record to obtain a TNO ciphertext, where the TNO ciphertext is included in a targeted selection;
b. aggregating over the targeted selection associated with the partition, wherein the aggregating comprises:
i. decrypting the targeted selection of TNO ciphertexts to obtain a set of data records; and
ii. performing reduction operations over the set of data records to obtain an aggregate data.

2. The method of claim 1 wherein the step of performing mapping operations to transform the initial data record into a Stage-1 data record comprises:
obtaining a first set of key-value pairs included in the initial data record;
obtaining a data point included in the Stage-1 data record;
user providing a filtering expression and a transformation expression;
transforming the first set of key-value pairs into a second set of key-value pairs in accordance with the filtering expression; and
transforming the second set of key-value pairs into the data point in accordance with the transformation expression.

3. The method of claim 1 wherein the step of performing mapping operations to transform the initial data record into a Stage-1 data record comprises:
obtaining a subform having a first key-value pair, where the subform is included in the initial data record including the subform as a value in a second key-value pair;
moving the first key-value pair to the initial data record from the subform; and
changing the key in the first key-value pair to a concatenation of the key in the second key-value pair and the key in the first key-value pair.

4. The method of claim 1 wherein the step of generating an index that identifies the partition based on the Stage-1 data record in accordance with a partition key comprises:
user providing a group-by expression;
obtaining a set of key-value pairs included in the initial data record; and
generating the index based on the set of key-value pairs in accordance with the partition key and the group-by expression.

5. The method of claim 1 wherein the step of generating an index that identifies the partition based on the Stage-1 data record in accordance with a partition key comprises:
obtaining a consent-to-use from a data subject of the initial data record; and
encrypting the index by using the consent-to-use as a key.

6. A computer implemented method as recited in claim 1, further comprising:
obtaining a consent-to-disclosure from a data subject of the TNO ciphertexts;
decrypting the index by using the consent-to-disclosure as a key; and
coupling the index with the aggregate data.

7. The method of claim 1 wherein the step of performing mapping operations to transform the initial data record into a Stage-1 data record comprises:
obtaining an executable expression embedded as a value of a key-value pair included in the initial data record; and
executing the expression for side-effects.

8. The method of claim 1 wherein the step of obtaining an initial data record comprises:
putting a user selection of initial data records into a queue;
obtaining a user session;
determining that the user session expires;
in response to determining that the user session has expired, waiting for renewal of the user session; and
in response to determining that the user session has a status other than expired, obtaining one or more initial data records from the queue for decryption.

9. A computer implemented method as recited in claim 8, further comprising:
obtaining a user selection of TNO ciphertexts in the TNO server; and
decrypting the TNO ciphertexts to obtain the initial data records for putting into the queue.

10. The method of claim 9 wherein the step of obtaining a user selection of TNO ciphertexts in the TNO server, the method comprising:
obtaining a user selection of a first data record from an external input source;
user providing a filtering expression and a transformation expression;
transforming the first data record into a second data record in accordance with the filtering expression;
transforming the second data record into a third data record in accordance with the transformation expression; and
encrypting the third data record with a user-supplied owner key to obtain a TNO ciphertext.

11. The method of claim 1 wherein the step of decrypting the targeted selection of TNO ciphertexts to obtain a set of data records comprises:
obtaining the TNO ciphertexts from the targeted selection to put into a queue;
obtaining a user session;
determining that the user session expires;
in response to determining that the user session has expired, waiting for renewal of the user session; and
in response to determining that the user session has a status other than being expired, obtaining one or more TNO ciphertexts from the queue for decryption.

12. A non-transitory computer-readable medium with instructions stored thereon, that when executed by a processor, perform the steps comprising:
obtaining an initial data record;
performing mapping operations to transform the initial data record into a Stage-1 data record;
generating an index that identifies a partition based on the Stage-1 data record in accordance with a partition key;
encrypting the Stage-1 data record with an owner key from an owner of the initial data record to obtain a TNO ciphertext, where the TNO ciphertext is included in a targeted selection;
decrypting the targeted selection of TNO ciphertexts to obtain a set of data records;
performing reduction operations over the set of data records to obtain an aggregate data;
obtaining a consent-to-use from a data subject of the initial data record;
encrypting the index by using the consent-to-use as a key;
obtaining a consent-to-disclosure from the data subject;
decrypting the index by using the consent-to-disclosure as a key; and
coupling the index with the aggregate data.

13. A data refining system for distributed aggregation of TNO ciphertexts, comprising:
a first processor that performs mapping operations to obtain a Stage-1 data record, encrypts the Stage-1 data record to obtain a TNO ciphertext, and generating an index that identifies a partition based on the Stage-1 data record in accordance with a partition key;
a first memory for storing the Stage-1 data record and the mapping operations;
an Index Caches for storing the partition having a targeted selection that includes the TNO ciphertext;
a TNO server for storing the TNO ciphertext;
a second processor that decrypts the TNO ciphertext to obtain the Stage-1 data record, and performs reduction operations to reduce the Stage-1 data record into an aggregate data;
a second memory for storing the reduction operations and the aggregate data;
wherein the first processor further encrypts the partition key and the index with a received consent-to-use, and the second processor further decrypts the partition key and the index with a received consent-to-disclosure for re-identifying the aggregate data.
